(19) United States
(12) Patent Application Publication
(10) Pub. No.: US 2001/0051525 A1
(43) Pub. Date: Dec. 13, 2001

(54) Radio communications newtwork

(76) Inventor: Mark W. Rayne, Cambridgeshire (GB)

Correspondence Address: SCHWEGMAN, LUNDBERG, WOESSNER & KLUTH, P.O. BOX 2938, MINNEAPOLIS, MN, 55402, US

(21) Appl. No.: 09/767,795

(22) Filed: Jan. 23, 2001

Related U.S. Application Data
(63) Continuation of application No. PCT/GB99/02400, filed on Jul. 23, 1999.

(30) Foreign Application Priority Data
Jul. 23, 1998 (GB) 9816087.2

(51) Int. Cl. H04Q 7/20

(52) U.S. Cl. 455/453; 455/445; 455/517

(57) ABSTRACT

A method of and apparatus for connecting calls to mobile stations (A to H) in a radio telecommunications network, such as a private mobile radio system or a cellular telephone system, so as to minimise call set-up delays and communication bottlenecks in the fixed part of the network. A plurality of location data caches (d1 to d4) are provided, each arranged to store location data for selected mobile stations capable of communicating via the network. Each location data cache (d1 to d4) is accessible by one or more base stations (b1 to b4) of the network. In the event that location data is required for a mobile station (A to H) that is not one of the selected mobile stations in a location data cache (d1 to d4) accessible to a base station, the base station (b1 to b4) requests location data from a location data store (dc) containing location data records for all the mobile stations of the network.

The present invention relates to a communications network and to a method of and apparatus for operating the same. In particular, the invention relates to a method of and apparatus for connecting calls to mobile stations in a radio telecommunications network, such as a private mobile radio system or a cellular telephone system, so as to minimise call set-up delays and communication bottlenecks in the fixed part of the network.

In general, a radio telecommunications network comprises a plurality of fixed base stations arranged to communicate with each other via a fixed communications network. Each base station is arranged to receive and transmit radio communications from mobile stations in the vicinity of the base station. The base stations are geographically distributed so that a mobile station within the area covered by the network is always in radio communication range of at least one base station. Thus, a mobile station is able to make a call by establishing radio communication with a nearby base station, which routes the call through the fixed network. Likewise, a mobile station can receive a call by radio communication with a nearby base station, the call having been routed to that base station via the fixed network. In this way, a mobile station which is only capable of relatively short range radio communication can communicate with other mobile stations anywhere within the coverage area of the network, because the fixed network acts as an intermediary to route calls between the mobile stations.

Such a communications network may be connected to other networks, such as a public telephone system, so that calls may be made from mobile stations to users of other networks and vice versa.

The aim of a radio telecommunications network is to allow the mobile stations to roam freely throughout the coverage area of the network while maintaining the ability to make and receive calls at all times. For this reason, it is necessary to maintain constantly updated information as to the location of each mobile station within the network, so that calls can be routed to that station if required. In order to achieve this, each mobile station registers with a base station with which it is in radio communication range. If the mobile station moves out of range of the base station with which it is registered, the mobile station registers with a new base station which is in range. A record is maintained which identifies at any given time the base station of the network which is in radio communication range of a given mobile station, so that calls to that mobile station can be routed to the correct base station.

In many mobile radio systems, it is desirable to provide rapid call set-up both for individual and group calls. Thus, the fixed network should rapidly identify the current location of the called mobile stations so that it can establish the availability of the mobile station or stations, and reserve radio channel and fixed line capacity for the call, in the shortest possible time. The fixed network should be able to handle many such call requests simultaneously without any increase in the call set-up time.

One way for the fixed network to locate a mobile station is to record its current location on a central database which is updated each time the mobile station registers with a new base station. In this way, each time a call set-up request is made, it is only necessary to access the central database to locate the mobile stations that are the intended participants in the call. However, delays will ensue as soon as more than one call request is made at the same time, because of the need to wait for access to the central database, and, as the call numbers rise, congestion in the connections leading to the central database.

Another way to proceed is to use a widely distributed database, where copies of all the location information that would be held in a cental database are stored at every switching unit, or at every base station. This eases the problem of congestion from call set-up requests, but introduces the new problem of having to update every database every time a mobile station moves to a new base station. Also the cost of the network is increased by the need to have multiple copies of a potentially very large database.

Yet another known way to identify the location and details of a called mobile station is to store this data in a set of distributed location databases without duplication, and to employ a mobile station numbering scheme which incorporates the identity of the relevant location database as part of the number (the first three digits of the mobile station's identity, for example) However, this method places constraints on the available numbers, is inefficient in the use of the number space, and is inflexible when it is desired to expand or reconfigure the system, or merge it with another system, for example.

In its first aspects, the present invention seeks to provide an alternative way of tracking the locations of mobile stations in a radio telecommunications network.

Viewed from one aspect the invention provides a radio communications network comprising a plurality of base stations arranged for wireless communication with a plurality of mobile stations, a plurality of location data caches each arranged to store location data for selected mobile stations capable of communicating via the network, each data cache accessible by one or more base stations of the network, and wherein each base station is arranged to request location data from a location data store in the event that location data is required for a mobile station that is not one of the selected mobile stations in a location data cache accessible to the base station.

Thus, in this aspect of the present invention, when a base station is required to locate a mobile station, location data for the mobile station is accessed from the location data cache. Only if the required location data is unavailable from the location data cache, is the data accessed from a location data store. In this way, it is not always necessary for the base station to obtain location data from the location data store. Thus the number of requests for location data to the location data store is reduced, and thereby the likelihood of congestion around the location data store is also reduced. Furthermore, the retrieval of location data from the location data cache is generally faster than the retrieval of location data from the location data store. Moreover, the network of the invention does not restrict the numbering of mobile stations and allows flexibility for reconfiguration of the system.

Viewed from a further aspect the invention provides a method of operating a radio communications network, the network comprising a plurality of base stations arranged for wireless communication with a plurality of mobile stations, the method comprising storing location data for selected mobile stations capable of communicating via the network at two or more location data caches, each location data cache being accessible by one or more base stations of the network, storing location data for all mobile stations capable of communicating via the network at a location data store and supplying location data to a base station on request from the location data store in the event that location data is required by the base station for a mobile station that is not one of the selected mobile stations in a location data cache accessible to the base station.

The location data caches may be arranged within the communications network as desired. Each location data cache may be associated with and provide location data to one or more base stations. Each base station preferably can only access a single location data cache. A location data cache may be in the same physical location as a base station or may be remote therefrom (for example, the location data cache may be provided at a switching unit or router of the network), although they are preferably local to the base station or stations that they serve.

In a particularly preferred embodiment each base station has its own location data cache, which is preferably accessible only by that base station.

Thus, viewed from a yet further aspect the invention provides a base station for a radio communications network, wherein the base station comprises a location data cache which is arranged to store location data for selected mobile stations capable of communicating via the network, and means for requesting location data from a location data store in the event that location data is required for a mobile station that is not one of the selected mobile stations.

Viewed from another aspect the invention provides a method of operating a base station of a communication network, the method comprising storing location data for selected mobile stations capable of communicating via the network at the base station and requesting location data from a location data store in the event that location data is required by the base station for a mobile station that is not one of the selected mobile stations.

The location data caches, particularly where they are located at each base station, are preferably accessible by their base station or stations independently of (i.e. without the need to use) the fixed communications network linking the base stations, as this reduces further congestion in the fixed communications network.

The selected mobile stations for which location data is stored in a data cache may be selected as desired. They are preferably mobile stations which have previously communicated through the base station or stations associated with the data cache, and most preferably are the mobile stations which have most recently communicated through those base station(s) For example, each time a call is set up, the location of the calling and called mobile stations may be stored in a location data cache associated with the base station through which the call is routed, i.e. the base station serving the calling mobile station and, optionally, also stored in a location data cache associated with the base station serving the called mobile station. In other words, when a mobile station communicates through a base station, its location and the location of any other mobile station it communicates with (e.g. all the mobile stations participating in the call) may be stored in that base station's associated location data cache. This has the advantage that the locations of mobile stations or groups of mobile stations that a particular mobile station regularly communicates with are likely to be stored in the location data cache associated with the base station that the particular mobile station is using.

The total number of selected mobile stations the location data of which is stored in the location data cache should be less than the total number of mobile stations capable of communicating via the network. Thus, the number of mobile stations the location data of which is stored in a location data cache is preferably limited in a predetermined manner. For example, the number of mobile stations for which location data is stored may be limited by the size limit of the location data cache. For example, they-could be the last 10 mobile stations to and/or from which the base station has routed a call. Alternatively, items of location data older than a certain, e.g. predetermined, limit may be deleted from the location data cache. In another alternative, the location data cache can be arranged to store only a predetermined number of location records, with the records being stored, e.g. on first-in, first-out basis. The location data cache is preferably also arranged to keep only one set of location data for each mobile station to optimise storage space and prevent duplication.

The location data stored in the location data cache may be the last known location of a particular mobile station, for example the location of that mobile station when a call was routed to it by the base station.

Additional data for each mobile station may be stored in the location data cache, for example availability information, chronological information relating to the last communication with that mobile station and/or associations between that mobile station and other mobile stations.

Each location data cache may also store the next location of a mobile station when that mobile station has moved from a base station associated with the location data cache. In this way, a trail may be formed which may be followed by a call set-up request. However, if a mobile station moves frequently between calls such a system may become inefficient.

The data stored in the location data cache and in particular the location data of the mobile stations is generally not updated every time the mobile stations move around the network between base stations. It would normally only be updated as and when a mobile station communicates through a base station associated with the location data cache (in which case that location data cache would add the mobile station to its list of location data, poss-ibly replacing the oldest existing location data with it).

The location data store in general contains a location data record for each mobile station capable of communicating with the network which is updated with the location of that mobile station each time the mobile station registers with a new base station. The location data store may be a central database containing location data records for all mobile stations in the network, and accessible by all base stations.

In a preferred arrangement, however, the overall location data store is in a distributed form, i.e. a plurality of location data stores are provided, with each location data store containing a location data record for at least one, but less than all mobile stations capable of using the network. This arrangement should be such that a location data record for each mobile station capable of using the network is stored, preferably only once, in the network. In this arrangement, the location data stores are distributed throughout the network, which means that requests to the location data stores by base stations for location data are also distributed around the communication links of the network, reducing bottlenecks. Furthermore, communications from base stations to the location data stores when a mobile station registers with a base station are also distributed. An index data store containing index data associating each mobile station with a location data store containing the location data record for that mobile station is preferably also provided, to facilitate locating of the distributed location data records of the mobile stations.

Thus, viewed from a further aspect the present invention provides a radio communications network comprising:

a plurality of base stations arranged for wireless communication with a plurality of mobile stations;

a plurality of location data stores, each location data store containing a location data record for at least one, but less than all mobile stations capable of using the network; and

an index data store containing index data associating each mobile station with a location data store containing the location data record for that mobile station.

Accordingly, a centralised store of all location data records, and the associated bottlenecks, is prevented, as is the necessity to maintain several copies of a single location database.

Viewed from a yet further aspect the present invention provides a method of operating a communication network, the network comprising a plurality of base stations arranged for wireless communication with a plurality of mobile stations, the method comprising:

providing a plurality of location data stores, each location data store containing a location data record for at least one, but less than all mobile stations capable of using the network; and

providing an index data store containing index data associating each mobile station with a location data store containing the location data record for that mobile station.

Each location data store may be associated with, for example in the same physical location as, a base station of the network. Alternatively, the location data stores may be located at junctions or switching units of the network. The location data record for each mobile station should be updated with the new location of the mobile station whenever the mobile station moves to a new location (i.e. registers with a new serving base station).

The location data record for a particular mobile station is advantageously stored in the location data store which can be accessed most rapidly by the base station that is used most frequently by that mobile station, for example a location data store located at that base station.

The index data store may be a central database containing index data for all mobile stations in the network, and accessible by all base stations. Alternatively, a plurality of index data stores may be provided each containing index data for all mobile stations in the network, in order to prevent bottlenecks at a central store. It will be appreciated that the index data only changes when a new mobile station is added to the network or the location data record of an existing mobile station is moved. Thus, the provision of multiple copies of the index data store is much less problematic than the provision of multiple location data stores containing copies of all location data records as described above.

As well as the index data store, a plurality of index data caches arranged to store index data for selected mobile stations and accessible by the base stations may be provided, such that each base station can access such an index data cache. In this arrangement, when a base station requires index data for a particular mobile station, for example to connect a call from another mobile station when the called mobile station is no longer in range of the called base station, the base station can attempt to access the index data in the first instance from its index data cache. Only in the event that index data for the required mobile station is unavailable from the index data cache, does the base station request the index data from the index data store. In this way, it is not always necessary for the base station to obtain index data from the index data store. Thus the number of requests for index data to the index data store is reduced, and thereby the likelihood of congestion around the index data store is also reduced. Furthermore, the retrieval of index data from the index data cache is generally faster than the retrieval of index data from the index data store.

Similarly to the location data caches, each index data cache may be associated with and provide index data to one or more base stations. The index data cache may be in the same physical location as a base station or may be remote therefrom. For example, the index data cache may be provided at a switching unit or router of the network. Preferably each base station has its own index data cache.

Also similarly to the location data caches, the selected mobile stations in the index data cache can be selected as desired, and are preferably mobile stations which have previously and preferably most recently communicated through the relevant base station(s). The selected mobile stations are preferably the stations the location data of which is stored in the location data cache for the same base station or stations, and thus may be selected in the same way. Similarly, the index data cache is preferably arranged to maintain only a limited amount of index data. For example, the oldest item of index data above a certain limit may be deleted from the index data cache. The index data cache may be arranged to keep only one set of index data f or each mobile station to optimise storage space and prevent duplication.

Additional data for each mobile station may be stored in the index data cache, for example location data, availability information, chronological information relating to the last communication with that mobile station and/or associations between that mobile station and other mobile stations.

Advantageously, the location data caches and index data caches are provided in the form of a plurality of single data caches each performing the role of a location data cache and an index data cache for the same selected mobile stations (and for the same base stations). Most preferably each base station is provided with a single such data cache. As mentioned above, the index data changes less frequently than the location data. Thus, even if the location data stored in the data cache of a base station is incorrect, the index data will generally remain correct and the appropriate location data store for that mobile station can be located from the index data in the data cache, without the need to retrieve index data from an index data store.

In a particularly preferred embodiment databases each comprising a location data store, a location data cache and an index data cache in combination are provided distributed across the network. Most preferably each base station is provided with a database which includes a location data store and a data cache for both index data and location data.

In use, the system of the above aspects of the present invention would typically operate as follows.

When a mobile station (the “calling mobile station”) makes a request to the base station at which it is registered (the “calling base station”) for a call to another mobile station (the “called mobile station”), and when location data for the called mobile station is stored in the calling base station's data cache, the calling base station would normally initially route the call to the base station (the “called base station”) indicated by the location data stored in the location data cache of the calling base station as the base station at which the called mobile station is registered.

In the event that the called mobile station has moved from the location indicated by the location data stored in the location data cache of the calling base station when the calling base station attempts to route the call to the called mobile station, the called base station at the wrongly indicated location may inform the calling base station that the called mobile station is no longer at that location and that the required location data must be retrieved from the location data store (using an index data store or cache to identify the relevant location data store, if appropriate).

Alternatively, the called base station could, if it can, pass the correct location data for the called mobile station from its own location data cache to the calling base station, or failing that it could retrieve the correct location data for the called mobile station from the location data store (again via the index data store or cache, if appropriate) and then pass it to the calling base station. In either of these cases, the called base station may route the call information to the actual location of the called mobile station.

When a base station (the “calling base station”) requests index data from the index data store to carry out a call request, the index data store may route the call request directly to the location data store indicated by the index data. Optionally, the location data store may then route the call request directly to the base station indicated by the location data (the “called base station”). Any of the index data store, the location data store or the called base station may communicate the retrieved index data to the calling base station.

In a particularly preferred embodiment, a call request message is forwarded through the communications network (e.g. by the base stations and/or location data caches or stores) in response to the location data, rather than the location data simply being returned to the calling base station. Thus, for example, if a base station receives a request for a call to a mobile station that is no longer served by that base station, the base station preferably forwards the call request to the base station at which the mobile station is located according to the location data in the data cache of the base station or, if no such location data is stored in the data cache, to the location data store. If the location data store receives a request for a call to a mobile station from a base station it forwards the call request to the base station at which that mobile station is located, according to the location data stored at the location data store. The call request will thus be forwarded to the base station at which the mobile station to be called is located, and this base station can then communicate with the base station that originated the call request (the call request would contain information identifying the originating base station). Furthermore, the originating base station is able to update its location data cache with the new location of the called mobile station.

Viewed from a broad aspect, therefore, the invention provides a radio communications network comprising at least one database storing calling data relating to at least some of the mobile stations capable of communicating via the network, wherein the database is arranged to receive a call request and to forward the call request, supplemented if possible with calling data from the database, in response to the calling data stored in the database in order to progress the call request through the network.

Thus, the database according to this aspect of the invention does not simply return calling data to the source of the call request, for example a base station of the network, but forwards the call request in response to the calling data stored in the database, in order to progress the call request through the network. In this way unnecessary network traffic is reduced, because there are no communications across the network that simply return calling data to a requesting base station. Once the call request reaches the base station (the “called base station”) at which the called mobile station is located, any calling data that has been retrieved from the database as the call request was forwarded through the network can be communicated by the called base station back to the calling base station.

Viewed from a further broad aspect, therefore, the invention provides a database for a radio communications network, wherein the database is arranged to store calling data relating to at least some of the mobile stations capable of communicating via the network, to receive a call request and to forward the call request, supplemented if possible with calling data from the database, in response to the calling data stored in the database in order to progress the call request through the network.

Viewed from a yet further broad aspect, therefore, the invention provides a method of operating a radio communications network, the method comprising storing calling data relating to at least some of the mobile stations capable of communicating via the network in a database, sending a call request to the database and forwarding the call request, supplemented if possible with calling data from the database, in response to the calling data stored in the database in order to progress the call request through the network.

Viewed from a further broad aspect, therefore, the invention provides a method of operating a database of a radio communications network, the method comprising storing in the database calling data relating to at least some of the mobile stations capable of communicating via the network, receiving a call request and forwarding the call request, supplemented if possible with calling data from the database, in response to the calling data stored in the database in order to progress the call request through the network.

The calling data may be location data as described above or other data, for example as described above or hereinafter. The database may be a location data cache or a location data store as described above or another database storing information relating to the mobile stations of the network, for example as described above or hereinafter.

The call request should be forwarded as appropriate to progress it through the network. For example, if the database stores location data for a called mobile station, e.g. it is a location data store, the call request may be forwarded by the database (location data store) to the base station at which the called mobile station is located, according to the location data stored in the database (location data store).

As a further example, if the database is a location data cache the call request may be forwarded by the location data cache to the base station at which the called mobile station is located, according to the location data stored in the location data cache. If the location data cache contains no location data for the called mobile station, the call request may be forwarded to the location data store.

In the event that a mobile station has moved through several base stations since it was last called by a particular base station there may exist an extended trail of location data stored at successive location data caches, following the path of the mobile station. This is undesirable, as a call request will follow the trail and may make many “hops”. If an error occurs in the updating of one of the location data caches, a loop may be created resulting in a call request going round the trail for ever. Messages sent through the communications network may therefore include a hop counter, for example set with an initial predetermined value when the message is sent and decremented from its previous value each time the message is passed on to another location. In this case, a message with a zero hop count, ie. messages that have made a predetermined number of hops, may be sent to the location data store, for example via an index data store, thereby cutting short the trail, and breaking any loops. An advantage of this mechanism is that in the event of long trails or loops it is self-correcting because the location data cache of a calling base station is updated with the called mobile station's current location, cutting short any extended trail.

Where an index data store or stores are provided, they are also preferably arranged to forward call requests in the manner described above. For example, when an index data store receives a call request it may supplement the call request with the identity of the location data store storing the location data record for the called mobile station and forward the call request to that location data store.

Similarly, the index data caches, if provided, are preferably arranged to forward call requests in the manner described above. For example the call request may be forwarded by the index data cache to the location data store containing the location data record for the called mobile station, according to the index data stored in the index data cache. If the index data cache contains no index data for the called mobile station, the call request may be forwarded to the index data store.

In the present invention, as is often the case in radio communications systems, plural mobile stations may be arranged in particular, e.g. predetermined, groups, such that a call may be made simultaneously to all members of the group. In this case, a location data record is preferably provided for the group which is constantly updated with the location of each of the members of the group. An index data record is also preferably provided in the index data store for each group.

A group data record for each mobile station may be provided which indicates the group membership of the mobile station. The group membership record may be maintained in the index data store, in the location data store or in a separate group data store (which may be a central store or may comprise a plurality of group data 5 stores distributed about the network with appropriate index data identifying the group data store for the particular mobile station) or two or more of these locations.

The location data cache of a base station may be arranged to store location data for selected groups of mobile stations, in the same way as for individual mobile stations. Likewise, the index data cache of a base station may be arranged to store index data for selected groups of mobile stations, in the same way as for individual mobile stations. The location data cache, the index data cache or a group data cache may be arranged to store group data indicating the group membership of selected mobile stations.

When a mobile station registers with a base station, the location data records for any groups of which that mobile station is a member, as identified by the group data of the mobile station, may be updated to indicate that a member of the appropriate group is located at that base station. Advantageously, the location data for the group is also transmitted to the location data cache of each base station at which a member of the group is currently located (i.e. registered or in radio communication with), according to the location data record for the group. In this way, if one mobile station (the “calling mobile station”) which is a member of the group requests a group call to all other mobile stations in the group (the “called mobile stations”), the location of each of the called mobile stations can be accessed quickly from the location data cache of the base station at which the calling mobile station is located.

Thus, according to a further aspect of the invention, there is provided a method of operating a radio communications network, the network comprising a plurality of base stations arranged for wireless communication with a plurality of mobile stations, the mobile stations comprising at least one talk group, wherein each base station with which a member of the talk group is registered is provided with a continually updated list of the base stations with which the other members of the talk group are registered.

Some embodiments of the invention will now be described by way of example only and with reference to the accompanying drawings, in which:

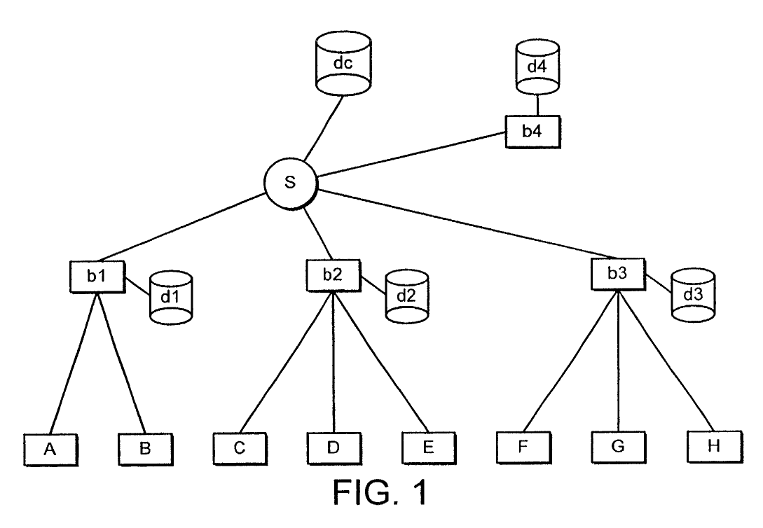

FIG. 1 illustrates the general arrangement of a mobile communications network according to the invention; and

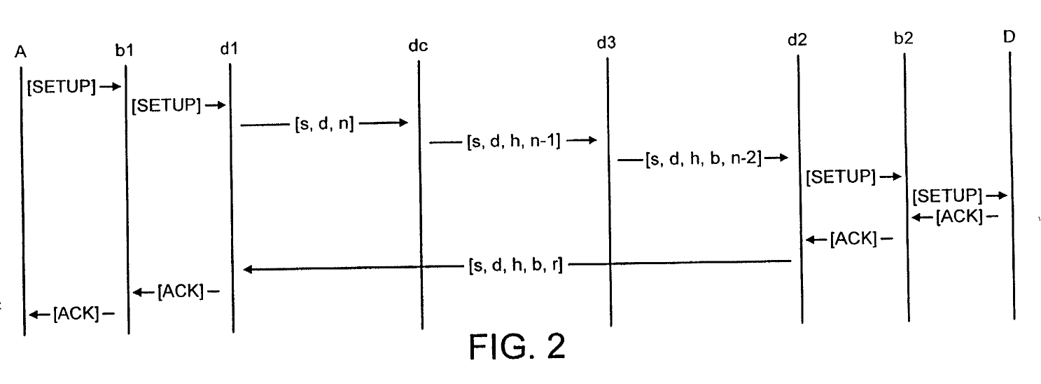

FIGS. 2 to 4 illustrate the setting-up of calls across the network of FIG. 1.

FIG. 1 shows an example of a radio telecommunications network according to the invention. The network comprises four fixed radio base stations b1 to b4 which are interconnected by network connections and a switching unit s which routes messages to their indicated addresses. This is a simplified representation of a communications network and other arrangements are possible, for example there may be many interconnected switches in a large national network, or the base stations may be interconnected directly.

The base stations b1 to b4 are each capable of radio communication with any of the mobile stations A to H authorised to use the network. In FIG. 1, mobile stations A to H are currently registered with base stations b1, b2 and b3 as shown. Thus, mobile stations A and B are in radio communication range of base station bi and calls to and from either of these mobile stations are routed through the fixed network via base station b1. Likewise, mobile stations C, D and E are in radio communication range of base station b2 and mobile stations F, G and H are in radio communication range of base station b3. No mobile stations are in range of base station b4 in the situation shown. Of course, the mobile stations are free to roam over the geographical area covered by the telecommunications network moving from the coverage area of one base station to another. Thus, FIG. 1 represents only an instantaneous view of the positions of the mobile stations A to H relative to the base stations b1 to b4.

Each of the base stations b1 to b4 is connected to a respective database d1 to d4, which contains a data store and a data cache. The databases are able to communicate with each other and with base stations over the network via the base stations to which they are connected. In general, the databases control the retrieval of the necessary data relating to the mobile stations required to set up a call, and the base stations control communications around the network and with mobile stations in their range.

A central database dc, which contains an index data store, is also connected to the network and is remote from but accessible by all of the base stations b1 to b4. The databases d1 to d4 and the central database dc are used to track the location of mobile stations using the network. The content and operation of the databases d1 to d4 and the central database dc will be described in detail in the following.

Each of the databases d1 to d4 contains, in its data store, location data records, or “home records”, for identities authorised to use the network. An authorised identity may be an individual mobile station or a group of mobile stations forming a talk group. A talk group allows all mobile stations in the group to be called simultaneously. Every authorised identity has a single home record, which is stored in one of the databases. The home record contains all information that the network requires relating to the particular identity, possibly with the exception of encryption and authentication keys, which may need to be stored in a physically secure location. The home record of a mobile station is always kept up to date with the location of the mobile station, i.e. the base station at which that mobile station is registered, and the list of groups of which the mobile station is a member. Thus, each time a mobile station moves from one base station to another the new base station transmits the new location of the mobile station to the home record. In the example shown in FIG. 1, there are four databases, each storing home records for a portion of the total set of authorised identities, with no duplication so that only a single home record exists for each identity. It is not necessary, however, for all databases to store home records.

For maximum efficiency, the home record for a particular mobile station is stored in the database linked to the base station most frequently used by that mobile station. Home records are preferably well distributed throughout the communications network to minimise congestion at the databases when many call requests occur simultaneously.

Table 1 shows the home records stored in the database at d4 in the example shown in FIG. 1. Item T in the home records of Table 1 is a group, the members of which are mobile stations A, B, D and H which are currently located at base stations b1, b2 and b3 respectively. Mobile stations A and H have their home records at database d4, and thus these home records show that mobile stations A and H are members of group T. Mobile station G is a member of groups R, S and V.

TABLE 1
Example of a set of home records stored in the
database at d4

| Identity | Location | Group Membership |
|---|---|---|
| A | b1 | T |
| G | b3 | R, S, V |
| H | b3 | T |
| T | b1 | |
| T | b2 | |
| T | b3 | |

The central database dc acts as an index data store and stores index data in the form of an identity index, which contains an entry for each mobile station and talk group identifying the database at which the home record for that mobile station or talk group is stored. Table 2 shows the identity index for the example network shown in the Figure.

It will be appreciated therefore that any base station requiring the location of a particular mobile station can refer to the identity index in the central database dc to find the database storing the home record for that mobile station and obtain the location for the mobile station from the identified database. However, this method of identifying the location of mobile stations is used only as a last resort according to the invention, as is explained below.

TABLE 2
Example identity index

| Identity | Database |
|---|---|
| A | d4 |
| B | d3 |
| C | d2 |
| D | d3 |
| E | d1 |
| F | d1 |
| G | d4 |
| H | d4 |
| T | d4 |

As mentioned above, each database d1 to d4 comprises a data cache, as well as the data store that contains the home records. The data cache contains details, including status, home record location, group membership and last known location of a selected number of the mobile stations, in this embodiment of the mobile stations which have most recently communicated through the base station connected with the database (up to the size limit of the data cache). However, the data cache is not updated every time a mobile station within the network changes location.

The greater the size of the data cache, the longer into the past its records stretch. The optimum size depends on a number of factors, such as the cost of cache memory, the number of mobile stations using the base station, the rate of call throughput etc. It is particularly important to preserve the records of mobile stations known to be present (registered) at that base station, until they move on, or their registration expires. The data cache provides the base station with a local store of the last recorded location of any mobile station that has recently communicated through the base station, so that the base station can route calls for that mobile station to the location stored in the data cache, which may still be the location of the mobile station.

Table 3 shows a possible format for the cache records in the data cache of database d2 in the example shown in FIG. 1. The data cache includes the location of the home record for each mobile station, the location of each mobile station when it last used the base station (b2) connected to the database containing the data cache, and the date/time of the last time the mobile station used this base station (“last access”) Since the data cache is of limited length, the records are arranged so that no mobile station has duplicate entries, i.e. old entries are always replaced by newer ones, and the oldest records are allowed to drop off the bottom of the data cache when space is required for new entries.

In the exemplified situation depicted in Table 3, mobile stations H and B are not within range of base station b2 and are therefore assigned the status “absent”. However, these mobile stations have recently been called, or made calls, through this base station and so their locations at the time of those calls are recorded in the data cache. At that time, mobile station B was at base station b4, but, in this example, unknown to database d2, has since moved to base station bi, as shown in FIG. 1. Mobile station H was at base station b3 when it communicated via base station b2, and remains at base station b3. Mobile station A was formerly registered at base station b2 but has since moved away to a location unknown to database d2.

TABLE 3
Possible format of cache records at database d2

| Identity | Status | Home | Groups | Location | Last access |
|---|---|---|---|---|---|
| D | free | d3 | T | b2 | 9803062115 |
| T | free | d4 | | b1 | 9803052318 |
| T | free | d4 | | b2 | 9803052318 |
| T | free | d4 | | b3 | 9803052318 |
| H | absent | d4 | T | b3 | 9803052201 |
| B | absent | d3 | T | b4 | 9803052111 |
| C | busy | d2 | | b2 | 9803050901 |
| E | free | d1 | | b2 | 9803041015 |
| A | absent | d4 | T | ? | 9803011213 |

The data cache at database d2 includes details for talk group T which has members at base stations b1, b2 and b3. As the data cache at database d2 is aware that no calls are being made to the members of talk group T located at base station b2, the data cache indicates that all members of group T are “free” to take calls. Mobile station C is engaged in communication via base station b2 and is therefore assigned the status “busy”.

As mentioned above, whenever a mobile station roams into the radio communication range of a new base station, the new base station sends a message via the communication network to the database containing the home record for the mobile station, advising the database of the current location of the mobile station, so that the home record can be updated. In the first instance, the new base station will attempt to identify the database storing the home record for the mobile station from the records stored in the data cache of the database connected to that base station. If the mobile station has recently been registered at that base station or if another mobile station has received a call at that base station from the newly arrived mobile station, the base station will already have a record in its data cache for the mobile station. If the data cache contains no record for the mobile station, because the mobile station has not communicated recently via the base station, the database sends the location updating message to the central database dc (the index data store), and the central database then forwards the location updating message to the location data store containing the home record for the mobile station. The location data store then sends a confirmation message to the location data cache associated with the new base station. The confirmation message contains the identity of the location data store and may include other information indicating the call profile and group membership of the mobile station. The location data cache at the new base station updates its records with this information. In this way, it is not always necessary for a base station to communicate with the central database to register the arrival of a mobile station within its communication range.

FIGS. 2 to 4 show exchanges of messages which occur in the following examples. These include local messages [setup] and [ack] exchanged between the mobile station, base station and database at a particular base site, and network messages. The network messages include the following information:

s source of the message, i.e. the base station that originated the call set-up request;

d destination of the message, i.e. the called mobile station;

h the location of the home record of the called mobile station;

b the base station at which the called mobile station is currently registered, or believed to be registered;

r the result of a call set-up, e.g. successful or unsuccessful; and

n a hop count which is decremented each time a message is forwarded from one database to another to limit the possibility of a message being endlessly passed around the network following a trail of previous locations of a mobile station.

If the hop count reaches zero the message is forwarded to the central database dc so that the correct current location of the called mobile station can be reliably included in the message.

As an example of the operation of the network, suppose that mobile station A, which is currently registered at base station b1 and whose home record is stored at database d4, informs base station b1, with a call set-up message [set-up], that it wishes to call mobile station D, which is currently registered at base station b2 and whose home record is at database d3.

The messaging involved in setting up the call is illustrated in FIG. 2, in which the messages are represented in square brackets.

Initially, base station b1 communicates the call set-up request to database d1 so that the location of mobile station D can be retrieved from the data cache at database d1. However, mobile station D has never communicated through base station b1 before, so the data cache at d1 has no information on mobile station D.

Database d1 therefore forwards the call set-up request to the central database dc via base station b1 and switching unit s. The message to the central database dc from database d1 includes the source (S) of the message, ie. database d1, the ultimate destination (d) of the call request, ie. mobile station D and a hop count (n), which is decremented each time the message is forwarded from one database to another. The central database dc notes from the content of the message from database d1 that base station b1 was unable to locate mobile station D. Thus, the central database dc retrieves the location (database d3) of the home record for mobile station D from the identity index.

Rather than simply passing the information as to the location of the home record of mobile station D back to base station b1, the central database dc forwards the call set-up request which now includes the location of the home record (h) of mobile station D, via base station b3, to database d3, where the home record of mobile station D is stored.

Database d3 retrieves the current location (base station b2) of mobile station D from the home record for mobile station D and forwards the call set-up request which now includes the current location (b) of mobile station D, via base station b2, to database d2. Database d2 checks the current status of mobile station D in its data cache. If mobile station D is apparently available (status “free”), database d2 passes the call request back to base station b2. In addition, database d2 updates its data cache, creating a new record in the data cache if necessary, with the current location of mobile station A which information was included in the call set-up request.

Base station b2 checks the actual availability of mobile station D by contacting it via the air-interface and reserves a radio channel and line capacity for the impending call. Base station b2 then sends an acknowledgement message fack) back to base station b1, advising it that mobile station D is at base station b2, and that base station b2 is ready to proceed with the call. The message also contains the other details of mobile station D which have been obtained during the call set-up procedure from the central database, such as the location (h) of the home record for mobile station D and in addition the message contains a result (r), e.g. “successful” or “unsuccessful” of the call set-up. Base station b1 communicates the details of mobile station D to database d1, which updates its data cache.

Preparation for the call is thus completed in four messages (b1 to dc, dc to b3, b3 to b2, b2 to b1) across the network's fixed links, excluding local connections between base stations and databases.

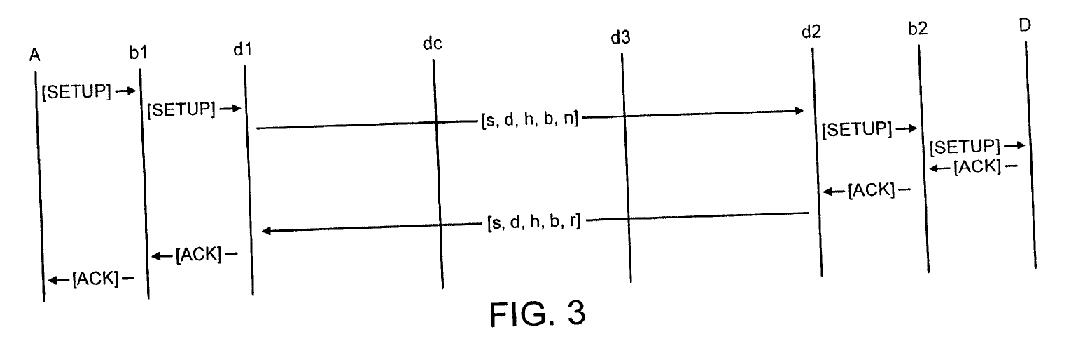

Suppose now that after the first call has been completed, mobile station A requests a further call to mobile station D. This exchange of messages is shown in FIG. 3. This time, the data cache of database d1 already contains details of mobile station D, including its most recently known location (base station b2), which it obtained at the time of the first call. Database d1 therefore sends the call request directly to database d2, which checks the status of mobile station D in its data cache and passes the request on to base station b2. Base station b2 checks the availability of mobile station D over the air interface and reserves radio and line channels, before sending the call request back to base station b1 for completion.

This time, the call preparation was completed using only two fixed-link messages.

Call set-ups between mobile stations A and D can now proceed according to this second method until either mobile station moves from the base station at which it is currently registered, or ceases to communicate through the base stations long enough for its record to drop off the bottom of the data cache at the base station at which the other mobile station is registered.

The effect of the foregoing is that the first time a mobile station is called from a particular base station, the set-up may be relatively slow, but in any further calls, within a period determined by the size of the data cache, call set-ups will be faster.

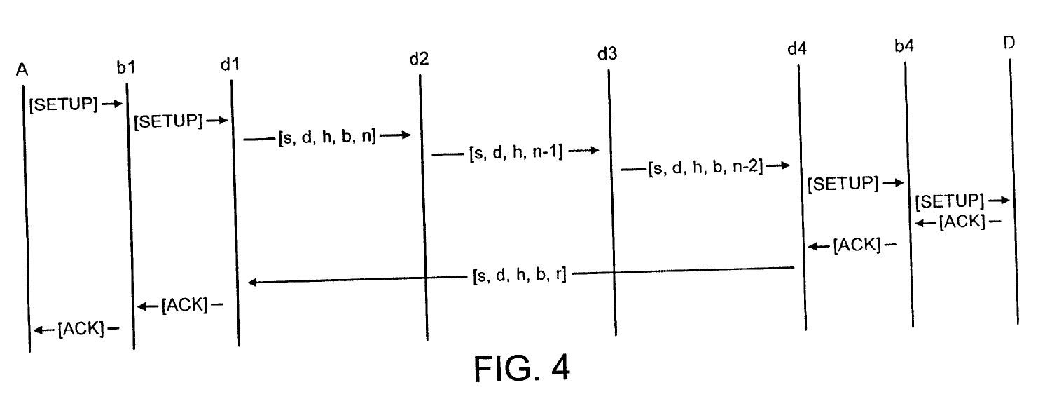

Consider now the case where mobile station D has roamed to a new base station, for example base station b4. This exchange of messages is shown in FIG. 4. As before, when mobile station A requests a call to mobile station D, database d1 sends the call set-up request to database d2, because the data cache at d1 indicates that mobile station D is at base station b2. Database d2 identifies from the status entry in its own data cache in respect of mobile station D that mobile station D is no longer present at base station b2 and that the home record of mobile station D is stored at database d3. Thus, database d2 forwards the call set-up request straight to database d3.

Database d3 identifies the current location of mobile station D from the home record for mobile station D in its data store, which was updated by a message from base station b4 when mobile station D registered there. Database d3 therefore forwards the call set-up request on to database d4, the database connected to base station b4 where mobile station D is currently located.

Database d4 informs base station b4 that mobile station D is present and base station b4 reserves channel and line capacity for the call and notifies base station bi that the call may proceed. Base station b1 advises database d1 of the new location of mobile station D, and database d1 updates its data cache accordingly.

This exchange takes four fixed-link messages, but it was not necessary to access the central database dc, preventing potential congestion around the central database. If all home records were held centrally at the central database dc, and database accesses were conducted as transaction pairs, four messages would be required for every call set-up request, and every call set-up request would go through the central database dc, causing congestion both at the central database dc and in the communication links leading to it.

It has been explained above how calls from an individual mobile station to another individual mobile station are set up according to the invention. The setting-up of a group call will now be explained.

In a group call, a mobile station requests a simultaneous call to a group of mobile stations which are all members of a “talk group”.

Suppose mobile station A wishes to call group T, comprising member mobile stations A, B, D and H. Fixed stations may also be included in a talk group, but for simplicity these are omitted from this example. The call set-up message is sent via the air interface from mobile station A to base station b1 where mobile station A is currently located. Base station b1 passes the call request to database d1 which identifies from its data cache that identity T is a group, as the group information was loaded into the data cache as soon as mobile station A or B registered at base station b1, because each of these mobile stations is a member of group T. Database d1 also identifies from the data cache that the home record for group T is stored at database d4. Database d1 therefore passes the call request to database d4.

Database d4 receives the call set-up request from database d1 and, from the home record of group T, identifies that members of group T are currently located at base stations b1, b2 and b3. Database d4 therefore sends the call set-up request straight to databases d1, d2 and d3. Databases d1, d2 and d3 check the status of the members of group T in their cache records and pass the call set-up request to their respective base stations b1, b2 and b3. Since group calls are generally set up immediately, base stations b2 and b3 reserve channel and line capacity and base station b1 connects the call.

This mechanism requires l+n messages across the network, where n is the number of base stations at which members of the group are registered. However, the elapsed time is that of two messages, as the n messages from the database storing the home record for the group are sent simultaneously.

According to a further embodiment, however, an even faster method for setting up group calls is disclosed. This method is most efficient if it is assumed that groups are much less numerous than individual mobile stations, so that the data cache of each database can store the full details, including the location of all group members, for all groups of which one or more members is currently registered at the base station connected to the database, and that group records in the data caches can be updated as member mobile stations move from base station to base station.

A data cache record for a group contains the group identity, a list of base stations at which mobile stations which are members of the group are currently registered and the database at which the home record for the group is stored. This information is also stored in the home record for the group.

Suppose mobile station H, a member of group T, was formerly at base station b2, but now registers at base station b3. Suppose also that the home record for group T is stored at database d4.

When mobile station H registers with base station b3, the base station informs its associated database d3. Database d3 identifies from its data cache that the home record for mobile station H is stored in the database at d2. Database d3 therefore informs database d2 that mobile station H has arrived at base station b3.

Database d2 updates the home record for mobile station H with the current location of mobile station H and identifies that mobile station H is a member of group T. Database d2 therefore locates the home record of group T (at database d4) either from its data cache or from the central database dc, and informs database d4 that there is now a member (H) of group T at base station b3.

Database d4 now updates the home record for group T with this information, and informs all databases which are connected to base stations at which members of group T are located that base station b3 must now be included in the list of locations where members of group T are to be found.

If the departure of mobile station H from base station b2 leaves base station b2 with no remaining members of group T, database d2 informs database d4 that base station b2 is to be removed from the list of locations where members of group T may be found. Again database d4 advises all databases connected to base stations where members of group T are currently located that base station b2 must be removed from their data cache records of the locations of members of group T.

In this way, every base station where a member of group T is currently located has a full list of every base station where calls to group T should be sent. This updating process does not have to be carried out at the speed of call set-ups, and may be performed as a background operation.

Now consider the example given above of a request by mobile station A to set up a call to group T. Mobile station A sends the call request, via the air interface, to base station b1. Base station b1 sends the request message to database d1, and database d1 identifies the current locations of all members of group T from its data cache. Assuming that this is a group call which does not need acknowledgments, database d1 informs base station bi of the locations of the members of group T, and base station b1 contacts all the necessary base stations.

This call set-up thus proceeds without any preliminary messages across the fixed network, permitting very fast group call establishment.

It will be seen from the above that according to the embodiments of the invention, the databases and the central database forward call requests across the network until sufficient information has been retrieved from the data caches, the databases and/or the central database to facilitate the call. The databases thus act as intelligent agents routing call requests through the network until the correct call control information can be returned to the call initiator, thereby reducing the size of the burst of messages required to set up a call.

1. A radio communications network comprising a plurality of base stations arranged for wireless communication with a plurality of mobile stations, a plurality of location data caches each arranged to store location data for selected mobile stations capable of communicating via the network, each data cache being accessible by one or more base stations of the network, and wherein each base station is arranged to request location data from a location data store in the event that location data is required for a mobile station that is not one of the selected mobile stations in a location data cache accessible to the base station.

2. The radio communications network of claim 1, wherein each base station can only access a single location data cache.

3. The radio communications network of claim 1 or claim 2, wherein the location data caches are accessible by their base station or stations independently of the fixed communications network linking the base stations.

4. The radio communications network of any one of the preceding claims, wherein the selected mobile stations are mobile stations which have previously communicated through the base station or stations associated with the location data cache.

5. The radio communications network of any one of the preceding claims, wherein location data for mobile stations which have most recently communicated through the base station or stations associated with a location data cache is preferentially stored in that location data cache.

6. The radio communications network of any one of the preceding claims, wherein the selected mobile stations are mobile stations which have previously participated in a call routed through the base station or stations associated with the location data cache.

7. The radio communications network of any one of the preceding claims, wherein when a call is routed through a base station, location data for both the calling and called mobile stations is stored in a location data cache associated with the base station.

8. The radio communications network of any one of the preceding claims, wherein the location data cache is arranged to store only a predetermined number of location records.

9. The radio communications network of any one of the preceding claims, wherein the location data stored in the location data cache is the last known location of the selected mobile station.

10. The radio communications network of any one of the preceding claims, wherein additional non-location data for each selected mobile station is stored in the location data cache.

11. The radio communications network of any one of the preceding claims, wherein each location data cache stores the next location of a selected mobile station when that mobile station has moved from a base station associated with the location data cache.

12. The radio communications network of any one of the preceding claims, wherein location data for a mobile station stored in a location data cache is only updated when that mobile station co mmunic ates through a base station associated with that location data cache.

13. The radio communications network of any one of the preceding claims, wherein the location data store contains a location data record for each mobile station capable of communicating in the network and which is updated with the location of a mobile station each time the mobile station registers with a new base station.

14. The radio communications network of any of the preceding claims, wherein the location data store comprises a plurality of location data stores and each location data store contains a location data record for at least one, but less than all mobile stations capable of using the network.

15. The radio communications network of claim 14, further comprising an index data store containing index data associating each mobile station with a location data store containing the location data record for that mobile station.

16. A radio communications network comprising:
a plurality of base stations arranged for wireless communication with a plurality of mobile stations;
a plurality of location data stores, each location data store containing a location data record for at least one, but less than all mobile stations capable of using the network; and
an index data store containing index data associating each mobile station with a location data store containing the location data record for that mobile station.

17. The radio communications network of claims 15 or claim 16, wherein the index data store is a central database containing index data for all mobile stations in the network and is accessible by all base-stations.

18. The radio communications network of any one of claims 15 to 17, having a plurality of index data stores, each index store containing index data for all mobile stations in the network.

19. The radio communications network of any one of claims 15 to 18, further comprising a plurality of index data caches arranged to store index data for selected mobile stations and accessible by the base stations, such that each base station can access such an index data cache.

20. The radio communications network of claim 19, wherein each base station has its own index data cache.

21. The radio communications network of claim 19 or claim 20, wherein the selected mobile stations in the index data cache are the stations the location data of which is stored in the location data cache for the same base station or stations.

22. The radio communications network of any of claims 19 to 21, wherein additional data for each mobile station is stored in the index data cache.

23. The radio communications network of any of claims 19 to 22, wherein each base station is provided with a single data cache for both index data and location data.

24. The radio communications network of any of claims 19 to 23, wherein each base station is provided with a database which includes a location data store and a data cache for both index data and location data.

25. The radio communications network of any one of claims 14 to 24, wherein each location data store is associated with a base station of the network.

26. The radio communications network of any one of claims 14 to 24, wherein the location data stores are located at junctions or switching units of the network.

27. The radio communications network of any one of the preceding claims, wherein the network is arranged such that if a first base station receives a request for a call to a mobile station that is no longer served by that base station, the first base station forwards the call request to the base station at the location indicated by the location data for the called mobile station in the location data cache of the first base station or, if no such location data is stored in the location data cache associated with the first base station, forwards the call request to the location data store.

28. The radio communications network of any one of the preceding claims, wherein each location data store is arranged such that if it receives a request for a call to a mobile station from a base station, it forwards the call request to the base station at the location indicated by the location data stored for the mobile station in the location data store.

29. The radio communications network of any one of the preceding claims, wherein each index data store is arranged such that when it receives a call request for a particular mobile station, it supplements the call request with the identity of the location data store storing the location data record for the called mobile station and forwards the call request to that location data store.

30. The radio communications network of any of one of the preceding claims, wherein each and index cache is arranged to forward a call request for a mobile station to the location data store indicated as containing the location data record for the called mobile station by the index data stored in the index data cache, and if the index data cache contains no index data for the called mobile station, to forward the call request to the index data store.

31. The radio communications network of any one of claims 27 to 30, wherein the network is arranged such that a call request that has been forwarded a predetermined number of times is forwarded to a location data store.

32. A radio communications network comprising at least one database storing calling data relating to at least some mobile stations capable of communicating via the network, wherein the database is arranged to receive a call request and to forward the call request, supplemented if possible with calling data from the database, in response to the calling data stored in the database in order to progress the call request through the network.

33. The radio communications network of claim 32 wherein the at least one database is a location data cache and the calling data is location data.

34. The radio communications network of any one of the preceding claims, wherein some of the mobile stations of the network are arranged in predetermined call groups, each call group including two or more mobile stations, and a location data record is stored for each call group which group location data record contains the location of each of the members of the group.

35. The radio communications network of claim 34, wherein an index data record is also provided in the index data store for each call group.

36. The radio communications network of claim 34 or 35 wherein there is further stored for each mobile station a group data record which indicates the call group membership of the mobile station.

37. The radio communications network of claim 34, 35 or 36, wherein the network is arranged such that when a mobile station registers with a base station, the location data records for all call groups of which that mobile station is a member are updated to indicate that a member of the appropriate call group is located at that base station.

38. The radio communications network of claim 34, 35, 36 or 37, wherein the network is arranged such that when a mobile station registers with a base station, the location data for any group of which that mobile station is a member is transmitted to the location data cache of each base station where the location data record for the group indicates that a member of the group is currently located.

39. A database for a radio communications network, wherein the database is arranged to store calling data relating to at least some of the mobile stations capable of communicating via the network, to receive a call request and to forward the call request, supplemented if possible with calling data from the database, in response to the calling data stored in the database in order to progress the call request through the network.

40. A base station for a radio communications network, wherein the base station comprises a location data cache which is arranged to store location data for selected mobile stations capable of communicating via the network, and means for requesting location data from a location data store in the event that location data is required for a mobile station that is not one of the selected mobile stations.

41. A method of operating a radio communications network, the network comprising a plurality of base stations arranged for wireless communication with a plurality of mobile stations, the method comprising storing location data for selected mobile stations capable of communicating via the network at two or more location data caches, each location data cache being accessible by one or more base stations of the network, storing location data for all mobile stations capable of communicating via the network at a location data store and supplying location data to a base station on request from the location data store in the event that location data is required by the base station for a mobile station that is not one of the selected mobile stations in a location data cache accessible to the base station.

42. The method of claim 41, wherein each base station can only access a single location data cache.

43. The method of claim 41 or claim 42, wherein the location data caches are accessible by their base station or stations independently of the fixed communications network linking the base stations.

44. The method of any one of claims 41 to 43, wherein the selected mobile stations are mobile stations which have previously communicated through the base station or stations associated with the location data cache.

45. The method of any one of claims 41 to 44, wherein location data for mobile stations which have most recently communicated through the base station or stations associated with a location data cache is preferentially stored in that location data cache.

46. The method of any one of claims 41 to 45, wherein the selected mobile stations are mobile stations which have previously participated in a call routed through the base station or stations associated with the location data cache.

47. The method of any one of claims 41 to 46, comprising storing, when a call is routed through a base station, location data for both the calling and called mobile stations in a location data cache associated that base station.

48. The method of any one of claims 41 to 47, wherein the location data cache stores only a predetermined number of location records.

49. The method of any one of claims 41 to 48, wherein the location data stored in the location data cache is the last known location of the selected mobile station.

50. The method of any one of claims 41 to 49, wherein additional non-location data for each selected mobile station is stored in the location data cache.

51. The method of any one of claims 41 to 50, wherein each location data cache stores the next location of a selected mobile station when that mobile station has moved from a base station associated with the location data cache.

52. The method of any one of claims 41 to 51, wherein location data for a mobile station stored in a location data cache is only updated when that mobile station communicates through a base station associated with the location data cache.

53. The method of any one of claims 41 to 52, wherein the location data store contains a location data record for each mobile station capable of communicating in the network and which is updated with the location of a mobile station each time the mobile station registers with a new base station.

54. The method of any one of claims 41 to 53, wherein there are a plurality of location data stores, and each location data store contains a location data record for at least one, but less than all mobile stations capable of using the network.

55. The method of claim 54, further comprising storing index data associating each mobile station with a location data store containing the location data record for that mobile station in an index data store.

56. A method of operating a radio communications network, the network comprising a plurality of base stations arranged for wireless communication with a plurality of mobile stations, the method comprising:
providing a plurality of location data stores, each location data store containing a location data record for at least one, but less than all mobile stations capable of using the network; and
providing an index data store containing index data associating each mobile station with a location data store containing the location data record for that mobile station.

57. The method of claim 55 or claim 56, wherein the index data store is a central database containing index data for all mobile stations in the network and is accessible by all base stations.

58. The method of any one of claims 55 to 57, wherein there are a plurality of index data stores, each index store containing index data for all mobile stations in the network.

59. The method of any one of claims 55 to 58, further comprising storing index data for selected mobile stations in a plurality of index data caches which are accessible by the base stations, such that each base station can access such an index data cache.

60. The method of claim 59, wherein each base station has its own index data cache.

61. The method of claim 59 or claim 60, wherein the selected mobile stations in the index data cache are the stations the location data of which is stored in the location data cache for the same base station or stations.

62. The method of any one of claims 59 to 61, wherein additional data for each mobile station is stored in the index data cache.

63. The method of any one of claim 59 to 62, wherein each base station is provided with a single data cache for both index data and location data.

64. The method of any one of claims 59 to 63, wherein each base station is provided with a database which includes a location data store and a data cache for both index data and location data.

65. The method of any one of claims 54 to 64, wherein each location data store is associated with a base station of the network.

66. The method of any one of claims 54 to 64, wherein the location data stores are located at junctions or switching units of the network.

67. The method of any one of claims 41 to 66, further comprising each base station, when it receives a request for a call to a mobile station that is no longer served by that base station, forwarding the call request to the base station at the location indicated by the location data for the called mobile station in the location data cache of the base station or, if no such location data is stored in the location data cache associated with the base station, forwarding the call request to the location data store.

68. The method of any one of claims 41 to 67, further comprising the location data store, if it receives a request for a call to a mobile station from a base station, forwarding the call request to the base station at the location indicated by the location data stored for the mobile station in the location data store.

69. The method of any one of claims 41 to 68, further comprising the index data store, when it receives a call request for a particular mobile station, supplementing the call request with the identity of the location data store storing the location data record for the called mobile station and forwarding the call request to that location data store.

70. The method of any of one of claims 41 to 69, further comprising each index data cache forwarding a call request for a mobile station to the location data store indicated as containing the location data record for the called mobile station by the index data stored in the index data cache, and if the index data cache contains no index data for the called mobile station, forwarding the call request to the index data store.

71. The method of any one of claims 67 to 70, wherein a call request that has been forwarded a predetermined number of times is forwarded to a location data store.

72. A method of operating a radio communications network, the method comprising storing calling data relating to at least some of the mobile stations capable of communicating via the network in a database, sending a call request to the database and forwarding the call request, supplemented if possible with calling data from the database, in response to the calling data stored in the database in order to progress the call request through the network.

73. A method of operating a database of a radio communications network, the method comprising storing in the database calling data relating to at least some of the mobile stations capable of communicating via the network, receiving a call request and forwarding the call request, supplemented if possible with calling data from the database, in response to the calling data stored in the database in order to progress the call request through the network.

74. The method of claim 72 or claim 73, wherein the calling data is location data and the database is a location data cache.

75. The method of any one of claims 41 to 74, wherein some of the mobile stations of the network are arranged in predetermined call groups, each call group including two or more mobile stations, further comprising storing a location data record for each call group which group location data record contains the location of each of the members of the call group.

76. The method of claim 75, wherein an index data record is stored in the index data store for each call group.

77. The method of claim 75 or 76, wherein there is further stored for each mobile station a group data record which indicates the call group membership of the mobile station.

78. The method of claim 75, 76 or 77, further comprising, when a mobile station registers with a base station, updating the location data records for all call groups of which that mobile station is a member to indicate that a member of the appropriate call group is located at that base station.

79. The method of claim 75, 76, 77 or 78, further comprising, when a mobile station registers with a base station, transmitting the location data for any call group of which that mobile station is a member to the location data cache of each base station where the location data record for the group indicates that a member of the group is currently located.

80. A method of operating a base station of a radio communications network, the method comprising storing location data for selected mobile stations capable of communicating via the network at the base station and requesting location data from a location data store in the event that location data is required by the base station for a mobile station that is not one of the selected mobile stations.

81. A method of operating a radio communications network, the network comprising a plurality of base stations arranged for wireless communication with a plurality of mobile stations, the mobile stations comprising at least one talk group, wherein each base station with which a member of the talk group is registered is provided with a continually updated list of the base stations with which the other members of the talk group are registered.

82. A radio communications network substantially as described with reference to the accompanying drawings.

83. A database for a radio communications network substantially as described with reference to the accompanying drawings.

84. A base station for a radio communications network substantially as described with reference to the accompanying drawings.

85. A method for operating a radio communications network substantially as described with reference to the accompanying drawings.

86. A method of operating a database of a radio communications system substantially as described with reference to the accompanying drawings.

87. A method of operating a base station of a radio communications system substantially as described with reference to the accompanying drawings.
